(19) United States
(12) Patent Application Publication
(10) Pub. No.: US 2002/0191291 A1
(43) Pub. Date: Dec. 19, 2002

(54) Birefringent devices and filters of temperature compensation

(76) Inventor: Bin Zhao, Irvine, CA (US)

Correspondence Address: STRADLING YOCCA CARLSON & RAUTH, IP Department, P.O. Box 7680, 660 Newport Center Drive, Suite 1600, Newport Beach, CA, 92660-6441, US

(21) Appl. No.: 10/016,729

(22) Filed: Nov. 30, 2001

Related U.S. Application Data
(60) Provisional application No. 60/254,390, filed on Dec. 8, 2000.

(51) Int. Cl. G02B 5/30; G02B 27/28; G02B 27/00

(52) U.S. Cl. 359/499; 359/500; 359/498; 359/577

(57) ABSTRACT

A temperature compensating phase delay element has a first light transmissive material and a second light transmissive material. The first and second light transmissive materials cooperate with one another in manner which mitigates changes in an optical path length of the transmissive element due to changes in temperature.

### PRIORITY CLAIM

This patent application claims the benefit of the filing date of U.S. Provisional Patent Application Serial No. 60/254,390, filed on Dec. 8, 2000, and entitled BIREFRINGENT DEVICES AND FILTERS OF PASSIVE TEMPERATURE COMPENSATION, the entire contents of which are hereby expressly incorporated by reference.

### CROSS-REFERENCE TO RELATED APPLICATIONS

This patent application is related to co-pending patent application Ser. No. 09/876,602, filed Jun. 7, 2001 and entitled BIREFRINGENT DEVICES (Docket Number 12569-02), and is related to co-pending patent application Ser. No. 09/876,819, filed Jun. 7, 2001 and entitled COMB FILTER FOR DENSE WAVELENGTH DIVISION MULTIPLEXING (Docket Number 12569-11), and is related to co-pending patent application Ser. No. 09/876,368, filed Jun. 7, 2001 and entitled INTERLEAVER USING SPATIAL BIREFRINGENT ELEMENTS (Docket Number 12569-03), and is related to co-pending patent application Ser. No. 09/891,795, filed Jun. 25, 2001 and entitled APPARATUS FOR CHANNEL INTERLEAVING IN COMMUNICATIONS (Docket Number 12569-04), and is related to co-pending patent application Ser. No. ______, filed ______ and entitled TEMPERATURE COMPENSATING REFLECTIVE RESONATOR (Docket Number 12569-07), all of which are commonly owned by the Assignee of this patent, the entire contents of all of which are hereby expressly incorporated by reference.

### FIELD OF THE INVENTION

The present invention relates generally to optical devices and relates more particularly to a temperature compensating phase-delay device which facilitates the construction of a temperature compensating optical filter suitable for use in optical communication systems.

### BACKGROUND OF THE INVENTION

Optical communications systems which utilize wavelength-division multiplexing (WDM) and dense wavelength-division multiplexing (DWDM) technologies are well known. According to both wavelength division multiplexing and dense wavelength-division multiplexing, a plurality of different wavelengths of light, preferably inferred light, are transmitted via a single medium, such as an optical fiber. Each wavelength corresponds to a separate channel and carries information generally independently with respect to the other channels. The plurality of wavelengths (and consequently corresponding plurality of channels) are transmitted simultaneously without interference with one another, so as to substantially enhance the transmission bandwidth of the communication system. Thus, according to wavelength-division multiplexing and dense wavelength-division multiplexing technologies, a greater amount of information can be transmitted than is possible utilizing a single wavelength optical communication system.

There are many applications for birefringent devices in optical communications and optical signal processing, including the construction of interleavers for multiplexing and demultiplexing channels in wavelength-division multiplexing (WDM) and dense wavelength-division multiplexing (DWDM) optical networks. The birefringence phenomenon provides a powerful method for manipulating optical beams in modem optical signal and image processing. Traditional birefringent devices are made of birefringent crystals, in which the phase velocity of an optical beam propagating in the crystals thereof depends upon the polarization direction of the optical beam. The shortcomings of such traditional crystal birefringent devices include limitations imposed by the crystal's physical, mechanical, and optical properties as well as limitations imposed by temperature stability, small birefringence values, nontuneable birefringence, and high cost in synthesis and fabrication.

Recently, several new spatial birefringent devices have been invented, wherein the birefringence is realized by optical path length difference in either free space or some other desired optical media for two orthogonally polarized optical beams. Wavelength filters or channel interleavers can be constructed by utilizing such spatial birefringent devices.

By using ultra-low expansion (ULE) or fused silica (or other materials having very low thermal expansion coefficient) as a gasket in device construction, excellent temperature stability in device performance can be obtained. In comparison to the conventional birefringent devices using birefringent crystals, the spatial birefringent devices overcome many limitations associated with the optical, physical, mechanical, and thermal properties of birefringent crystals. In addition, the device construction is simple and the device cost is low.

However, temperature changes cause undesirable instability in spatial birefringent devices, such as wherein path lengths and/or indices of refraction change with temperature in a manner which changes or degrades device performance characteristics. Therefore, it is desirable to provide passive temperature compensation for such spatial birefringent devices, such as wavelength filters or channel interleavers, so as to mitigate the undesirable effects of temperature changes. The low temperature dependence of such devices is desirable in many applications for performance stability at both the device level and the system level.

### BRIEF SUMMARY OF THE INVENTION

The present invention specifically addresses and alleviates the above-mentioned deficiencies associated with the prior art. More particularly, the present invention comprises a temperature compensating phase delay element which comprises a first light transmissive material and a second light transmissive material. The first and second light transmissive materials cooperate with one another in manner which mitigates changes in an optical path length of the transmissive element due to changes in temperature.

These, as well as other advantages of the present invention, will be more apparent from the following description and drawings. It is understood that changes in the specific structure shown and described may be made within the scope of the claims without departing from the spirit of the invention.

### BRIEF DESCRIPTION OF THE DRAWINGS

FIG. 1 is a cross-sectional view schematic diagram showing one spatial birefringent element configured so as to provide temperature compensation;

FIG. 2 is a top view schematic diagram of a polarization beam splitter birefringent device utilizing mirrors and utilizing a spatial birefringent element constructed according to FIG. 1 to facilitate temperature compensation therefor;

FIG. 3 is a top view schematic diagram of a polarization beam splitter birefringent device utilizing prisms and utilizing a spatial birefringent element constructed according to FIG. 1 to facilitate temperature compensation therefor;

FIG. 4 is a top view schematic diagram of a polarization beam displacer birefringent device utilizing prisms and utilizing a spatial birefringent element constructed according to FIG. 1 to facilitate temperature compensation therefore; and

FIG. 5 is a top view schematic diagram of a 2-stage interleaver utilizing a spatial birefringent element constructed according to FIG. 1 in each stage thereof to facilitate temperature compensation therefore.

### DETAILED DESCRIPTION OF THE INVENTION

The detailed description set forth below in connection with the appended drawings is intended as a description of the presently preferred embodiments of the invention and is not intended to represent the only forms in which the present invention may be constructed or utilized. The description sets forth the functions of the invention and the sequence of steps for constructing and operating the invention in connection with the illustrated embodiments. It is understood, however, that the same or equivalent functions and sequences may be accomplished by different embodiments that are also intended to be encompassed within the spirit and scope of the invention.

As discussed in detail below and illustrated in the accompanying drawings, a birefringent effect can be achieved utilizing two spatial paths, wherein the length of the two spatial paths differs so as to provide the desired birefringent effect. That is, the birefringent effect is provided by separating a beam of light into two orthogonally polarized components thereof, transmitting each of the two orthogonally polarized components along two separate paths wherein each path has a different optical path length (due to differences in physical path length and/or index of refraction along each path) and then recombining the two components so as to form a new composite light beam. The optical path length difference introduce a phase delay between the two orthogonally polarized optical components. Thus, free space or any desired light transmissive material may be utilized to achieve a birefringent effect analogous to that achieved by the fast and slow axis of a birefringent crystal. The use of this kind of spatial birefringent devices to achieve such a birefringent effect has advantages when compared with the use of birefringent crystals. For example, it eliminates the cost associated with purchasing birefringent crystals, the difficulty associated with manufacturing and assembling birefringent crystals, and the concerns associated with the quality of birefringent crystals.

However, the use of spatial devices for birefringence does suffer from some inherent disadvantages. For example, birefringent devices or filters which use only free space, i.e., a difference in physical path lengths, to achieve a birefringent effect will tend to be undesirably large. This is because of the comparatively long path lengths required to achieve a desired phase delay in free space. Thus, in comparison to the configuration of using free space for birefringence, the configuration of using a solid optical material (e.g., an optical glass) for birefringence provides an advantage in smaller device size since the refractive index of a solid medium is usually larger than that of free space. The use of a solid material, such as optical glass, facilitates the construction of smaller devices because the comparatively higher refractive index of such a solid material inherently provides a given phase delay utilizing a shorter path length.

When a solid medium is used as phase delay element in spatial birefringent devices, it can, for example, be a parallel plate of thickness L. Anti-reflection coatings are applied to the front-side and back-side of the plate so that the reflection coefficients at both surfaces are zero or close to zero. The phase delay caused by a single pass through such a phase delay element is δ=2π·nL·cos θ/λ=2π·nL/λ(θ=0° for normal incidence), where n is the refractive index of the medium, θ is the incidence angle in the medium, and λ is the optical wavelength. The product nL is the optical path length for a medium. The temperature dependence of the optical path length (OP) can be written as:

$$\frac{ⅆ O P}{ⅆ T} = \frac{ⅆ ( n L )}{ⅆ T} = \frac{ⅆ n}{ⅆ T} L + n \frac{ⅆ L}{ⅆ T} \qquad ( 1 )$$

The thermal coefficient of optical length path is:

$${α}_{O P} = \frac{1}{O P} \frac{ⅆ O P}{ⅆ T} = \frac{1}{n} \frac{ⅆ n}{ⅆ T} + \frac{1}{L} \frac{ⅆ L}{ⅆ T} = {α}_{n} + {α}_{L} \qquad ( 2 )$$

where αₙ is the thermal coefficient of refractive index and α_{L} is the thermal expansion coefficient for the solid medium. For an optical glass, a typical medium used for precision optical instruments, the typical value for αₙ is about 1-2 ppm/° C. and the typical value for α_{L} is about 6-10 ppm/° C. Thus, the thermal coefficient of optical path length is on the order of 10 ppm/° C. The large value of thermal coefficient of optical path length would lead to intolerable temperature dependence of the phase delay δ, which would result in significant undesired temperature dependence in device performance characteristics.

According to contemporary methodology, the temperature dependence of a transmissive medium can be reduced by utilizing a glass material for the phase delay element, where:

αₙ≈−α_{L} (3)

Examples of such materials include one glass with αₙ=−1.88 ppm/° C. and α_{L}=1.90 ppm/° C. and another glass with αₙ=−8.5 ppm/° C. and α_{L}=8.6 ppm/° C. The resultant thermal coefficients of optical path length are 0.02 ppm/° C. and 0.1 ppm/° C., respectively, for these two examples. These thermal coefficients of optical path length are orders of magnitude less than the thermal coefficient values of most contemporary optical materials. Thus, the temperature dependence of device performance characteristics is significantly reduced. Of course, if a glass material is chosen such that:

αₙ+−α_{L}

then the temperature dependence is completely eliminated.

The above described contemporary passive temperature compensation technique is very effective to reduce the temperature dependence of optical devices and thereby enhance their performance characteristics. However, making a glass material such that −αₙ and α_{L} are very close to or equal to each other is usually very difficult due to various limitations in material properties and in glass synthesis process.

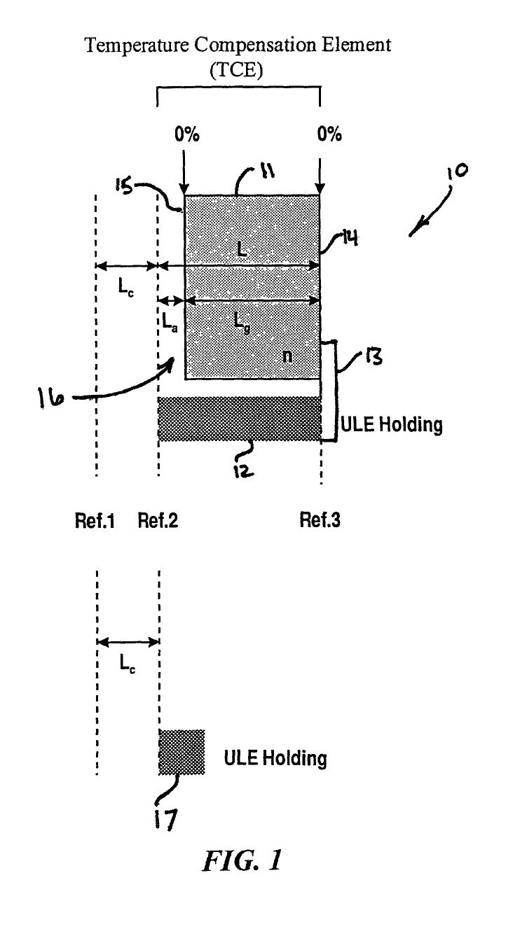

Referring now to FIG. 1, an exemplary temperature compensation element (TCE) 10 of the present invention is schematically shown. This TCE 10 serves as a phase delay element. Thus, the TCE 10 may be utilized to provide a desired phase delay in a spatial birefringent device, as discussed in detail below. The use of such a TCE 10 in a spatial birefringent device or in any other optical device decreases the temperature dependence of the device and consequently enhances the performance characteristics thereof.

On the top of FIG. 1 is a cross-sectional view of a TCE 10 constructed according to the present invention. The TCE 10 comprises a light transmissive media, such as glass 11, and is attached to ultra-low expansion (ULE) holding material 12, such as via support 13. Glass 11 is attached at a first surface 14 to the ULE holding material 12 and the second surface 15 of the glass 11 is not supported, such that it is free to move due to thermal expansion. The portion of an optical path length defined by the TCE 10 and controlled thereby is equal to the length of the ULE holding material 12. Typically, the ULE holding material 12 will separate two adjacent optical elements (such as mirrors and waveplates) and will define the distance therebetween. In this sense the ULE holding material defines a spacer between two adjacent optical elements.

Space or gap 16 has a length Lₐ and is the portion of the length of the temperature compensating element 10 which is the difference between the length of the ULE holding material 12 and the length of the glass 11. The gap 16 may contain air, vacuum, liquid, or any other desired light transmissive material which facilitates expansion of the glass 11 into the gap 16.

The TCE 10 functions as a phase delay element, so as to provide a phase delay for one beam of light (such as a beam of light passing horizontally therethrough along the top of FIG. 1). This phase delay is with respect to another beam (which may be regarded as a reference beam) such as a beam which travels horizontally along the lower portion of FIG. 1. As schematically shown in FIG. 1, both beams travel along a common distance L_{c} and the phase delay between the two optical beam is completely caused by TCE 10. It is important that distance L_{c} be a substantially common path to both optical beams, such that any thermal effects encountered by one beam are also encountered by the other beam, so that the only phase delay (or phase difference between the two beam) is the phase delay introduced by phase delay element 10.

The ULE holder 17 is used to control a portion of the optical path of a reference beam. Thus, the ULE holder 12 controls a portion of the path length of one component (such as a component beam of a spatial birefringent device) and also facilitates temperature compensation via the phase delay element 10, while ULE holder 17 facilitates control of the path length of a second component (such as the other component beam of a spatially birefringent device). In this manner, the only difference in optical path length between the first and second components is that difference intentionally introduced by phase delay element 10 (which performs both a phase delay function and a temperature compensation function).

In the operation of a spatial birefringent device, one of the two optical beams travels through the TCE 10 and a phase delay δ=2πOP/λ is added to this beam in comparison to the other optical beam. OP is the optical path length from reference plane 2 (Ref. 2) to reference plane 3 (Ref. 3) in the TCE 10.

In a spatial birefringent device, the optical path length from reference plane 1 (Ref. 1) to reference plane 2 is the same for both optical beams. For easy comparison, the common optical path length (from Ref. 1 to Ref. 2) for the non-delayed optical beam is schematically shown at the bottom of FIG. 1. The space covered by L_{c} in FIG. 1 can be free space or be filled by other solid media, as desired. It is important that when the temperature changes, the change in OP from Ref. 1 to Ref. 2 is the same for both optical beams, such that the phase delay between the two optical beams is only caused by the optical path length from reference plane 2 to reference plane 3 in TCE 10.

As shown in FIG. 1, the TCE 10 consists of a parallel plate of medium (e.g., glass) which only partially occupies the space between Ref. 2 and Ref. 3. The thickness of the parallel plate is L_{g}, which typically has a value of 1-10 mm. Both surfaces of the parallel plate are preferably non-reflective, i.e., the reflection coefficients are 0% (or close to 0%). The gap between one surface of the parallel plate and Ref. 2 is Lₐ and typically has a value of 10-200 um.

The gap is preferably filled with air or vacuum. However, the gap may be filled with any flexible light transmissive material having the desired optical properties. For example, the gap may alternatively be filled with a transparent fluid. The material which fills the gap may be changeable, so as to vary the phase delay associated with the TCE 10. The distance between the other surface of the parallel plate (located at Ref. 3) and Ref. 2 is L and L is controlled by using a ULE material between Ref. 2 and Ref. 3. Typical values for thermal expansion coefficient α_{ULE} in ULE materials are on the order of 0.01-0.1 ppm/° C. These descriptions indicate that

L=L_{g}+Lₐ (5)

Lₐ<<L_{g} (6)

Lₐ<<L (7)

L_{g}≈L (8)

The optical path length of the TCE 10 between Ref. 2 and Ref. 3 is given by

OP=n_{g}L_{g}+nₐLₐ≈n_{g}L_{g} (9)

where n_{g} and nₐ are the refractive index of the parallel plate and the refractive index of the gap, respectively. The temperature dependence of the optical path length can be written as

$$\frac{ⅆ O P}{ⅆ T} = \frac{ⅆ {n}_{g}}{ⅆ T} {L}_{g} + {n}_{g} \frac{ⅆ {L}_{g}}{ⅆ T} + \frac{ⅆ {n}_{a}}{ⅆ T} {L}_{a} + {n}_{a} \frac{ⅆ {L}_{a}}{ⅆ T} \qquad ( 10 )$$

Using Eqs. (5)-(10), the thermal coefficient of optical path length is:

$${α}_{O P} = \frac{1}{O P} \frac{ⅆ O P}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{U L E} \frac{{n}_{a}}{{n}_{g}} \qquad ( 11 )$$

where αₐ is the thermal coefficient of refractive index for the gap (either air or vacuum), αₙ is the thermal coefficient of refractive index and α_{L} is the thermal expansion coefficient for the parallel plate.

The first two terms in Eq. (11) are typically large (on the order of 10 ppm/° C.) as we discussed before. The third term in Eq. (11) is small due to the fact that nₐLₐ<<n_{g}L_{g} in this design and αₐ is usually about −1 ppm/° C. for air and zero for vacuum. The last term in Eq. (11) is also small because the typical value of α_{ULE} is on the order of 0.01-0.1 ppm/° C. To reduce the thermal coefficient of optical path α_{OP}, a glass material with

$${α}_{n} \approx - {α}_{L} \frac{{n}_{g} - {n}_{a}}{{n}_{g}} \qquad ( 12 )$$

can be chosen for the parallel plate in the TCE 10. Notice the difference between Eq. (12) and Eq. (3). Eq. (12) can lead to significant reduction in α_{OP}. α_{OP} can be further reduced by proper choices of Lₐ and α_{ULE}. Thus, manipulation of the gap size and material and manipulation of the ULE material facilitate further reductions in α_{OP}.

The following example further elucidates the concept of the present invention. A glass material, S-FPL51, from Ohara Corporation is chosen for the parallel plate in a TCE 10. The related material parameters for S-FPL51 glass are: n_{g}=1.486, dn_{g}/dT=−6.5 ppm/° C., α_{L}=13.3 ppm/° C. A TCE 10 as schematically shown in FIG. 1 is designed with Lₐ=100 um, L_{g}=2 mm and a ULE material (e.g., CLEARCREAM glass from Ohara Corp.) with αₙ=0.1 ppm/° C. Plug these numbers into Eq. (11) and note that nₐ≈1 and dnₐ/dT≈−1 ppm/° C. for the air gap, we get op −0.01 ppm/° C., which is orders of magnitude less than the original thermal coefficient value of optical path length for the phase delay element. Thus, the temperature dependence of device performance characteristics is substantially reduced.

The undesirable effects of temperature changes are mitigated according to present invention by at least of one of the two following factors. First, undesirable changes in phase delay due to changes in the distance L between the surface 14 of the light transmissive material 11 and the surface 15 are mitigated via the use of mounting of the light transmissive material 11 at the surface 14 thereof so as to facilitate expansion and contraction of the light transmissive material 11 within the distance L (such that the distance L does not change too much during such expansion and contraction) and via the use an ultra low expansion material (α_{ULE} is small) to partially define the holder (12, 13, 17).

According to the present invention, various conditions may be utilized so as to mitigate temperature dependence of the optical path length of a phase delay element. In each instance, the optical path length of the phase delay element is made to be more stable with respect to temperature by either reducing individual terms of Eq. (11) or by causing terms or combinations of terms thereof to substantially cancel one another. That is, the temperature dependence of a phase delay element is mitigated by manipulating the terms of Eq. (11) in a manner which reduces α_{OP}.

For example, use of a thermally stable material for the holding 12 minimizes α_{ULE} and thereby minimizes the fourth term of Eq. (11), so as to consequently reduce α_{OP}.

Further, making L_{g} much greater than Lₐ results in a reduced third term of Eq. (11), thereby reducing α_{OP}.

That is, the light transmissive material 11 is selected such that αₙ is opposite in sign to α_{L} (n_{g}−nₐ)/n_{g} and as close as possible in absolute value thereto.

Terms of Equation (11) may be made to cancel one another by, for example, by selecting a light transmissive material 11 such that αₙ=−a_{L} (n_{g}−nₐ)/n_{g} (αₙ is the thermal coefficient of refractive index of medium 11, αₙ=(1/n_{g})(dn_{g}/dT); α_{L} is the thermal expansion coefficient of medium 11, α_{L}=(1/L_{g}) (dL_{g}/dT); n_{g} is a refractive index of medium 11 and nₐ is a refractive index of the gap 16. Thus, α_{OP} can be mitigated via selection of the material for the holding 12 and via the selection of dimensions of Lₐ and L_{g}.

According to one aspect of the present invention, a polarity of light transmissive mediums are used to control the optical path length such that temperature dependence of the optical path length is minimized. For example, one medium, light transmitting material 11, may be allowed to expand into a second, flexible medium, such as air, vacuum, or a fluid which fills the gap 16. Thus, the phase delay element of the present invention comprises more than one light transmissive medium wherein the light transmissive media cooperate in a manner which mitigates temperature dependence of the optical path length thereof.

According to one aspect of the present invention, αₙ, nₐ, Lₐ, αₐ, n_{g}, L_{g}, α_{g}, and α_{ULE} are selected so as to mitigate the temperature dependence of the optical path length of the phase delay element.

Moreover, it is important to appreciate that L does not necessarily have to be fixed and that α_{ULE} does not necessarily have to be very small (such as less than 0.1 ppm/° C.). Rather, L can be permitted to change, as long as this change is compensated for. As long as at least one other term in Eq. (11) changes in a manner which compensates for such changes in L, then such changes in L may be permitted and are desirable in some cases.

One possible way in which a phase delay element of the present invention may be constructed so as to mitigate changes in the optical path length thereof due to temperature changes is to configure the phase delay element such that the first and second terms of Eq. (11) substantially cancel one another, Lₐ is very small with respect to L_{g} such that the third term of Eq. (11) is very small and such that α_{ULE} is as close as possible to zero. In this manner, α_{OP} is minimized and a substantially thermally stable phase delay element is provided.

However, those skilled in the art will appreciate that the four terms of Eq. (11) may be configured in various other manners so as to similarly minimize α_{OP}. According to the present invention, the values of the terms of Equation (11) cooperate so as to mitigate the value of α_{OP}. Any combination of terms may cancel or reduce any other combination of terms.

In above discussion, the used values for various parameters are exemplary and other values for these parameters are possible to achieve passive temperature compensation. FIG. 1 is only used for the purpose of illustrating the basic concept of this invention. It is understood that various configurations can be used to construct the phase delay element of temperature compensation based on the spirit of this invention.

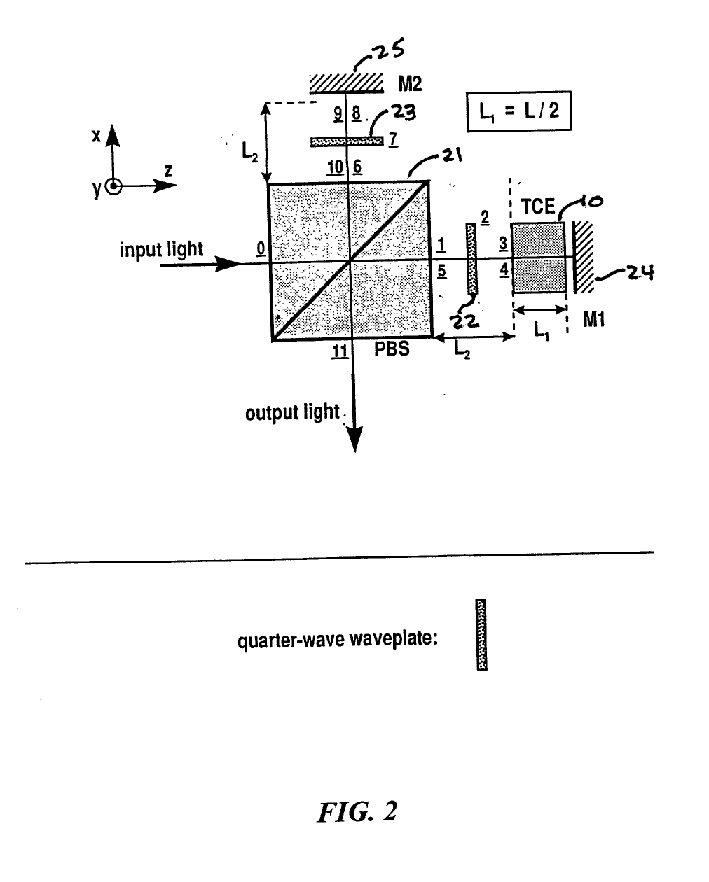

Referring now to FIG. 2, a top view of a spatial birefringent device using a TCE 10 according to the present invention as shown. The spatial birefringent device comprises a polarization beam splitter (PBS) 21, two quarter-wave waveplates 22 and 23, and two mirrors or etalons 24 and 25. When a beam of unpolarized light enters the PBS 21, it splits into two output beams according to the optical field polarization direction. For the input optical component polarizing in the x direction (within the paper plane), it leaves the PBS 21 in a propagation direction parallel to the original input beam propagation direction. For the input optical component polarizing in the y direction (perpendicular to the paper plane), it leaves the PBS 21 in a propagation direction orthogonal to the original input beam propagation direction.

A right-hand coordinate system of axes is used at various locations, with a convention that the light is always propagating in the +z direction and the +y direction is always out of the paper plan of FIG. 2.

At location 0, the input unpolarized optical beam has two linearly polarized components 1 (along the y direction) and 2 (along the x direction). Only component 2 travels to location 1. The optic axis of the quarter-wave waveplate 22 at location 2 is oriented at 45° with respect to the +x axis. Thus, the light at location 3 is circularly polarized. After it is reflected by mirror or etalon 24, it remains as a circularly polarized light with a reversed rotation direction at location 4. After it passes the quarter-wave waveplate 22, it becomes a linear polarized light with polarization direction along the y direction (location 5). When it enters the PBS 21 again, it is deflected to propagate to location 11. Similarly, for component 1, it travels through locations 6, 7, 8, 9 and 10.

Similarly, the optic axis of the quarter-wave waveplate 23 at location 7 is oriented at 45° with respect to the +x axis. At location 10, the linear polarized light has a polarization direction along the x direction. Thus, component 1 can propagate directly from location 10 to location 11.

Since there is a TCE 10 between PBS 21 and mirror or etalon 24 and since the rest of optical paths for component 1 and component 2 are the same, there is a phase difference Γ=2δ=4πOP/λ between component 1 and component 2 when component 1 and component 2 are combined at location 11, where OP is the optical path length of the TCE 10 given by Eq. (9). As we discussed above, the thermal coefficient of OP for the TCE 10 is very small. Thus, the temperature dependence of the spatial birefringent device is very small.

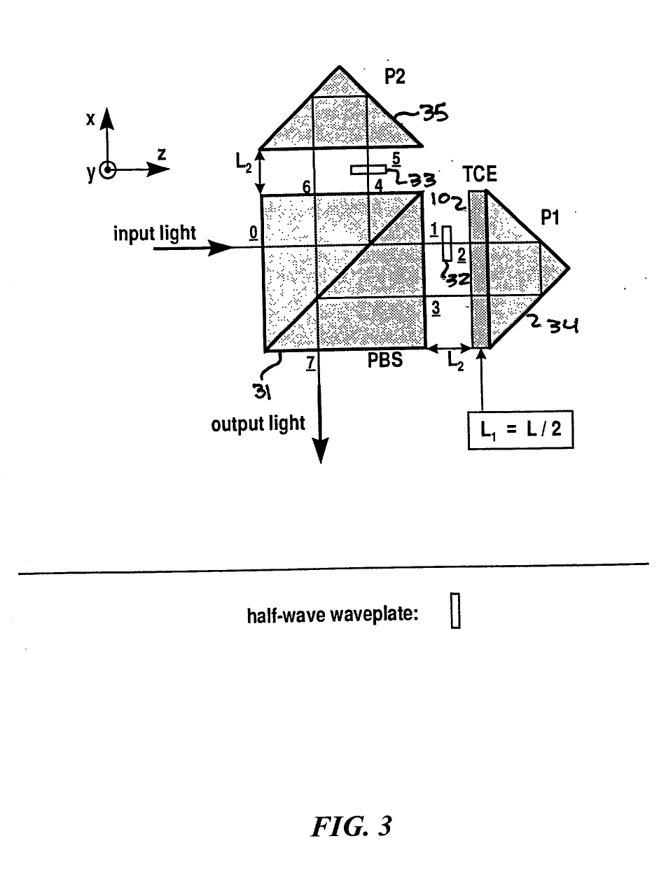

Referring now to FIG. 3, an alternative configuration of a birefringent device of the present invention is shown. The mirrors (or etalons) are replaced by right-angle prisms 34 and 35 and the quarter-wave waveplates are replaced by half-wave waveplates 32 and 33. The light component polarized along the x direction propagates through location 1, 2, and 3 and the light component polarized along the y direction propagates through locations 4, 5, and 6. The purpose of the half-wave waveplates is to rotate the optical beam polarization direction by 90°. The two components join each other at location 7. Similarly, the phase difference Γ(Γ=2δ=4πOP/λ) between the two orthogonally polarized light components is controlled solely by the optical path length of the TCE 10 (OP). The extremely low thermal coefficient of OP for the TCE 10 leads to very small temperature dependence for the spatial birefringent device.

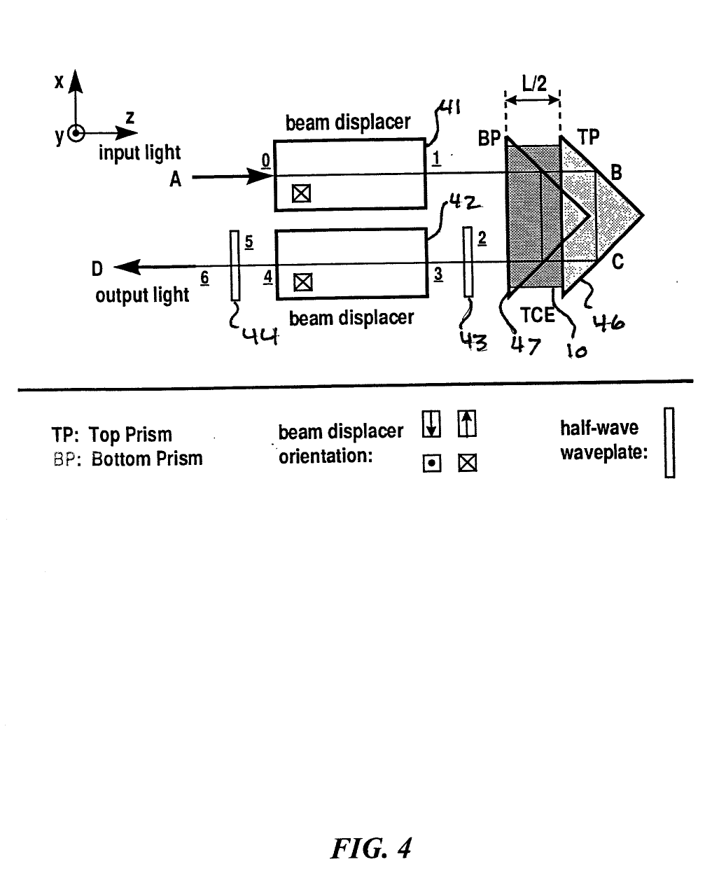

Referring now to FIG. 4, a top view of a further alternative configuration of the present invention is shown. The spatial birefringent device comprises polarization beam displacers (PBD) 41 and 42, half-wave waveplates 43 and 44 and two right-angle prisms 45 and 46. When a beam of unpolarized light enters the first PBD 41, it splits into two output beams according to the optical field polarization direction. For the input optical component polarizing in the x direction (within the paper plane), the component leaves the first PBD 41 along the original optical path defined by the input beam. For the input optical component polarizing in the y direction (perpendicular to the paper plane), the component leaves the PBD 41 in the same direction as the input beam but its optical path is shifted downward from the original path defined by the input beam.

The shift direction can be used to characterize a beam displacer by using the arrows shown in FIG. 4. The arrows indicate the beam shift direction for a beam displacer under study. There are two prisms 46 and 47 in the device, the top prism (TP) 46 and the bottom prism (BP) 47.

A TCE 10 is placed above the BP 47 so that its two end surfaces exactly match the locations of the front surfaces of TP 46 and BP 47, respectively, as shown in FIG. 4.

At location 0, the input unpolarized optical beam has two linearly polarized components 1 (along the y direction) and 2 (along the x direction) at top beam position. After the beam propagates through the first beam displacer 41, component 2 remains at the top beam position and component 1 shifts to bottom beam position. After component 2 passes the TCE 10, it enters the top prism 46 and is deflected a couple of times before passing through the TCE 10 again and encountering the half-wave waveplate 43.

Similarly, the component 1 enter the bottom prism and is deflected a couple of times before hitting the half-wave waveplate 43. The half-wave waveplate 43 changes the polarization direction of components 1 and 2 by 90°. After they pass the second beam displacer 42, component 1 remains at the bottom beam position and component 2 shifts from the top beam position to the bottom beam position. The phase difference Γ(Γ=2δ=4πOP/λ) between the two orthogonally polarized light components is controlled solely by the optical path of the TCE 10 (OP). The extremely low thermal coefficient of OP for the TCE 10 leads to very small temperature dependence for the spatial birefringent device.

It is possible to construct various different wavelength filters or channel interleavers utilizing the temperature compensation element (TCE) 10 of the present invention so as to enhance the performance characteristics thereof. In each instance, a birefringent effect will be provided via spatial birefringence, wherein an input light beam is divided into at least two components thereof and the two components are caused to travel along different optical paths, wherein the optical path length of each optical path is defined, at least in part, by physical differences and/or materials having desired indices of refraction. According to the present invention, a temperature compensating element (TCE) 10 substantially reduces physical path length by introducing a material having an index of refraction which is higher than that of air or free space. The problems due to changes in temperature commonly associated with the use of such materials are mitigated by configuring the materials such that such undesirable temperature changes are, at least in part, compensated for, as discussed above.

Optical interleavers are useful in optical communications for high performance and high capacity. Such channel interleavers may, optionally, comprise multiple birefringent stages and each stage thereof may, optionally, comprise a TCE 10. Further, the channel interleaver may be constructed in a fold configuration, wherein light is transmitted therethrough in a first direction and is subsequently reflected back therethrough in a second direction, so as to effectively double the number of stages without necessarily doubling the number of components utilized. In this manner, optimal space efficiency is achieved.

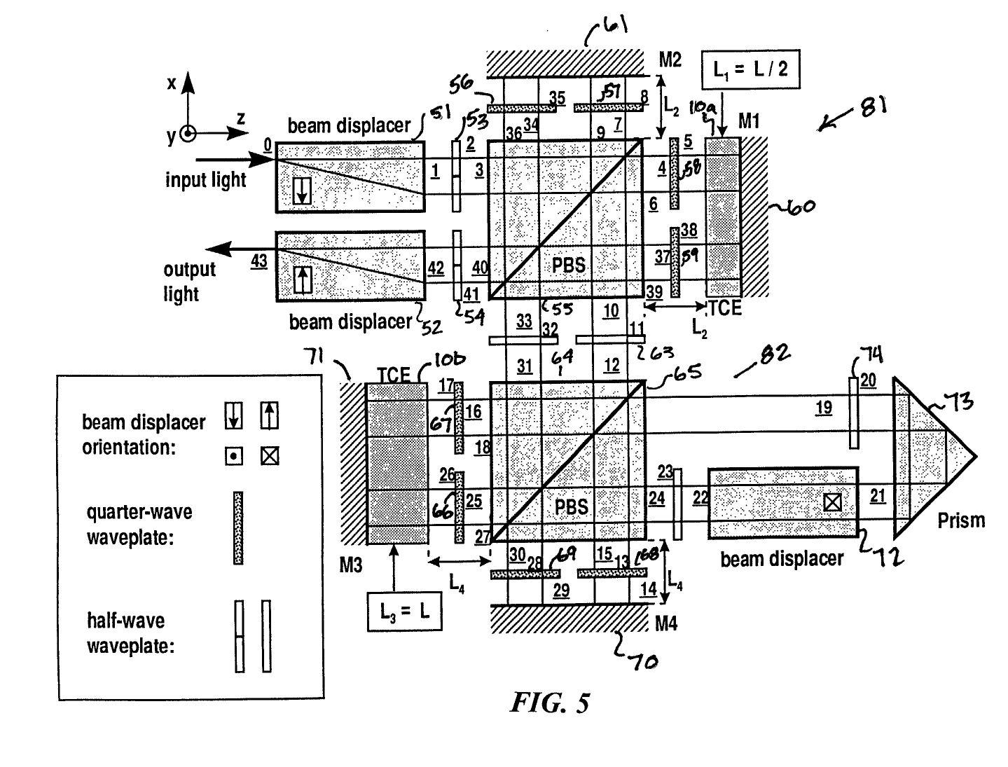

Referring now to FIG. 5, one example of such a multiple stage, fold interleaver utilizing temperature compensation elements according to present invention is shown. This interleaver utilizes two stages, 81 and 82, wherein each stage comprises a birefringent device similar to that shown in FIG. 2. The interleaver is configured such that light beams pass through each stage twice (once in a forward direction and once in a reverse direction) such that four stages of interleaving are effectively provided so as to enhance performance characteristics.

More particularly, input light from position 0, is separated into two components thereof by beam displacer 51 according to polarization directions of the two components. Each of the two components exits the first beam displacer 51 at position 1 and is transmitted through half-wave waveplates 53 which are oriented so as to define polarization direction of each of the components at an angle of 45° with respect to the x axis at position 3 such that the polarization beam splitter 55 separates each of the two components into two subcomponents of approximately equal amplitude. One of the two subcomponents continues traveling along the original direction and is transmitted through quarter-wave waveplate 5, then transmitted through TCE 10a, reflected by mirror 60 and is then transmitted back through TCE 10a. Quarter-wave waveplate 58 is oriented so as to cause the subcomponent polarization direction to be changed by 90° and transmitted therethrough back to the polarization beam splitter 55 to be substantially entirely reflected downwardly to position 10. The other subcomponent is reflected by the polarization beam splitter 55 such that it is transmitted through quarter-wave waveplate 57 and reflected by mirror 61 in a similar manner. Quarter-wave waveplate 57 rotates the polarization direction of the reflected component by 90° so that it will be transmitted through the polarization beam splitter 55. Both subcomponents are combined by polarization beam splitter 55 and are then travel downwardly.

The second stage 82 operates in a similar manner with the exception light output therefrom is directed back through the interleaver by prism 73. That is, each of the light beams which travel downwardly from polarization beam splitter 55 and separates into two components thereof One component continues to travel downwardly to mirror 70, while the other component is reflected through TCE 10b to mirror 71. The components are recombined by polarization beam splitter 65, from which they travel to prism 73 which redirects the light back through the polarization beam splitters 65 and 55. Polarization beam displacer 72 separates the odd channels and even channels from each other before they are transmitted back through the two stages 81 and 82. Beam displacer 52 recombines subcomponents from the first stage 81 so as to get the odd and even channel output of the interleaver.

It is understood that the exemplary phase delay element of temperature compensation described herein and shown in the drawings represents only a presently preferred embodiment of the present invention. Indeed, various modifications and additions may be made to such embodiments without departing from the spirit and scope of the invention. For example, those skilled in the art will appreciate that various different substantially rigid and substantially flexible material may be utilized in the construction of the present invention. Thus, these and other modifications and additions may be obvious to those skilled in the art and may be implemented for use in a variety of different applications.

What is claimed is:

1. A temperature compensating phase delay element comprising:
a first light transmissive material;
a second light transmissive material; and
wherein the first and second light transmissive materials cooperate with one another in manner which mitigates changes in an optical path length of the phase delay element due to changes in temperature.

2. The temperature compensating phase delay element as recited in claim 1, wherein:
the first light transmissive material comprises a substantially solid material; and
the second light transmissive material comprises a substantially flexible material.

3. The temperature compensating phase delay element as recited in claim 1, wherein:
the first light transmissive material comprises a solid material; and
the second light transmissive material comprises a material selected from the group consisting of:
air;
vacuum; and
liquid.

4. A temperature compensating phase delay element comprising:
ultra-low expansion holding material definging a distance between its first and second ends;
a solid light transmissive material attached to the ultra-low expansion holding material such that a first end surface of the solid light transmissive material is substantially fixed in position with respect to the first end of ultra-low expansion holding material and a second end surface of the solid light transmissive material is generally free to move with respect to the ultra-low expansion material;
a gap formed along the distance defined by the ultra-low expansion material;
wherein a thermal coefficient of optical path length is given by the formula
$${α}_{O P} = \frac{1}{O P} \frac{ⅆ O P}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{U L E} \frac{{n}_{a}}{{n}_{g}} \qquad ( 11 )$$
wherein αₙ is the thermal coefficient of the refractive index for the solid light transmissive material, α_{L} is the thermal expansion coefficient for the solid light transmissive material;
n_{g} is index of refraction for the solid light transmissive material, nₐ is the index of refraction for a material dispose intermediate the second end surface of the solid light transmissive material and the second end of the ultra-low expansion material, αₐ is the thermal coefficient of refractive index for the material dispose intermediate the second end surface of the solid light transmissive material and the second end of the ultra-low expansion material, Lₐ is the distance between the second end surface of the solid light transmissive material and the second end of the ultra-low expansion material, L_{g} is the thickness of the solid light transmissive material, and α_{ULE} is the thermal coefficient of expansion for the ultra-low expansion material; and
wherein the thermal coefficient of optical path length is mitigated by at least one of:
minimizing terms of Equation 11;
substantially canceling the terms among one another of Equation 11.

5. The temperature compensating phase delay element as recited in claim 4, wherein the ultra-low expansion holding material and the solid light transmission material are configured to provide a desired and substantially temperature independent phase delay to a optical beam with respect to a reference optical beam.

6. A temperature compensating light transmissive element comprising:
ultra-low expansion holding material having first and second ends;
a solid light transmissive material attached to the first end of the ultra-low expansion holding material such that a first end of the solid light transmissive material is substantially fixed in position with respect to the ultra-low expansion holding material and a second end of the solid light transmissive material is generally free to move with respect to the ultra-low expansion material;
a gap formed between the second end of solid light transmissive material and the second end of the ultra-low expansion material;
wherein a thermal coefficient of optical path length is given by the formula
$${α}_{O P} = \frac{1}{O P} \frac{ⅆ O P}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{U L E} \frac{{n}_{a}}{{n}_{g}} \qquad ( 11 )$$
wherein αₙ is the thermal coefficient of the refractive index for the solid light transmissive material, α_{L} is the thermal expansion coefficient for the solid light transmissive material;
n_{g} is index of refraction for the solid light transmissive material, nₐ is the index of refraction for a material dispose intermediate the second end of the solid light transmissive material and the second end of the ultra-low expansion material, αₐ is the thermal coefficient of refractive index for the material dispose intermediate the second end of the solid light transmissive material and the second end of the ultra-low expansion material, Lₐ is the distance between the second end of the solid light transmissive material and the second end of the ultra-low expansion material, L_{g} is the thickness of the solid light transmissive material, and α_{ULE} is the thermal coefficient of expansion for the ultra-low expansion material; and
wherein the thermal coefficient of optical path length is mitigated by configuring the light transmissive material such that the first two terms of Eq. (11) substantially cancel one another, L_{g} is much greater than Lₐ such that the third term of Eq. (11) is approximately zero, and α_{ULE} is substantially zero.

7. A method for mitigating undesirable efforts due to temperature changes in an optical phase delay element or the like, the method comprising;
holding a first end of a light transmitting material approximately fixed with respect to a first end of a low-expansion material and allowing a second end of the light transmissive material for move with respect to a second end of the low-expansion material;
wherein at least two contributing terms of equation (11) substantially cancel one another; and
wherein the rest of the contributing terms of equation (11) are approximately minimized.

8. A method for mitigating undesirable effects due to temperature changes in an optical phase delay element, the method comprising:
holding a first end of a light transmitting material approximately fixed with respect to a first end of a low-expansion material and allowing a second end of the light transmissive material for move with respect to a second end of the low-expansion material; and
wherein each contributing term in Equation (11) substantially cancel one another.

9. A temperature compensating phase delay element comprising:
a light transmitting material having a front surface and a back surface;
a holder configured to hold the back surface of the light transmitting material at approximately a fixed position with respect to the holder; and
wherein the light transmitting material and the holder are configured so as to define a gap proximate the front surface of the light transmitting material.

10. The temperature compensating phase delay element as recited in claim 9, wherein the light transmitting material comprises glass.

11. The temperature compensating phase delay element as recited in claim 9, wherein the light transmitting material comprises Ohara Corporation S-FPL51 glass.

12. The temperature compensating phase delay element as recited in claim 9, wherein:
the front surface of the light transmitting material has a reflection coefficient which is approximately zero; and
the back surface of the light transmitting material has a reflection coefficient which is approximately zero.

13. The temperature compensating phase delay element as recited in claim 9, wherein the holder comprises an ultra-low expansion material.

14. The temperature compensating phase delay element as recited in claim 9, wherein the holder comprises a material having a thermal expansion coefficient of approximately 0.1 ppm/° C.

15. The temperature compensating phase delay element as recited in claim 9, wherein the holder comprises Ohara Corporation Clearcream glass.

16. The temperature compensating phase delay element as recited in claim 9, wherein a thickness of light transmitting material is much larger than a thickness of the gap.

17. The temperature compensating phase delay element as recited in claim 9, wherein the light transmitting material, the reflector and the holder define a Gires-Tournois resonator.
